(19) United States
(12) Patent Application Publication
(10) Pub. No.: US 2023/0026322 A1
(43) Pub. Date: Jan. 26, 2023

(54) Data Processing Method and Apparatus

(71) Applicant: Huawei Technologies Co., Ltd., Shenzhen (CN)

(72) Inventors: Guilin Li, Shenzhen (CN); Bin Liu, Shenzhen (CN); Ruiming Tang, Shenzhen (CN); Xiuqiang He, Shenzhen (CN); Zhenguo Li, Hong Kong (CN)

(21) Appl. No.: 17/948,392

(22) Filed: Sep. 20, 2022

Related U.S. Application Data
(63) Continuation of application No. PCT/CN2021/077375, filed on Feb. 23, 2021.

(30) Foreign Application Priority Data
Mar. 20, 2020 (CN) 202010202053.7

(51) Int. Cl. G06N 3/08; G06N 3/04

(52) U.S. Cl. CPC G06N 3/08; G06N 3/0454

(57) ABSTRACT

A data processing method related to the field of artificial intelligence includes adding an architecture parameter to each feature interaction item in a first model, to obtain a second model, where the first model is a factorization machine (FM)-based model, and the architecture parameter represents importance of a corresponding feature interaction item; performing optimization on architecture parameters in the second model to obtain the optimized architecture parameters; and obtaining, based on the optimized architecture parameters and the first model or the second model, a third model through feature interaction item deletion.

### CROSS-REFERENCE TO RELATED APPLICATIONS

This is a continuation of International Patent Application No. PCT/CN2021/077375 filed on Feb. 23, 2021, which claims priority to Chinese Patent Application No. 202010202053.7 filed on Mar. 20, 2020. The disclosures of the aforementioned applications are hereby incorporated by reference in their entireties.

### TECHNICAL FIELD

This disclosure relates to the field of artificial intelligence, and in particular, to a data processing method and an apparatus.

### BACKGROUND

With rapid development of Internet technologies, an information overload problem occurs. To resolve the information overload problem, a recommender system (RS) emerges. Click-through rate (CTR) prediction is an important step in the recommender system. Whether to recommend a commodity needs to be determined based on a predicted CTR. In addition to a single feature, a feature interaction also needs to be considered during CTR prediction. To represent the feature interaction, a factorization machine (FM) model is proposed. The FM model includes feature interaction items of all interactions of single features. In a conventional technology, a CTR prediction model is usually built based on an FM.

A quantity of feature interaction items in the FM model increases exponentially with an order of a feature interaction. Therefore, with an increasingly higher order, the feature interaction items become numerous. As a result, there is an extremely large computing workload in FM model training. To resolve this problem, feature interaction selection (FIS) is proposed. Manual FIS is time-consuming and labor-intensive. Therefore, automatic FIS (AutoFIS) is proposed in the industry.

In an existing automatic FIS solution, search space formed by all possible feature interaction subsets is searched for an optimal subset, to implement FIS. A search process consumes high energy and consumes a large amount of computing power.

### SUMMARY

This disclosure provides a data processing method and an apparatus, to reduce a computing workload and computing power consumption of FIS.

According to a first aspect, a data processing method is provided. The method includes adding an architecture parameter to each feature interaction item in a first model, to obtain a second model, where the first model is an FM-based model, and the architecture parameter represents importance of a corresponding feature interaction item, performing optimization on architecture parameters in the second model, to obtain the optimized architecture parameters, obtaining, based on the optimized architecture parameters and the first model or the second model, a third model through feature interaction item deletion.

The FM-based model represents a model built based on the FM principle, for example, includes any one of the following models: an FM model, a DeepFM model, an Incremental Probabilistic Neural Network (IPNN) model, an Attentional FM (AFM) model, and a Neural FM (NFM) model.

The third model may be a model obtained through feature interaction item deletion based on the first model.

Alternatively, the third model may be a model obtained through feature interaction item deletion based on the second model.

A feature interaction item to be deleted or retained (or selected) may be determined in a plurality of manners.

Optionally, in an implementation, a feature interaction item corresponding to an architecture parameter in the optimized architecture parameters whose value is less than a threshold may be deleted.

The threshold represents a criterion for determining whether to retain a feature interaction item. For example, if a value of an optimized architecture parameter of a feature interaction item is less than the threshold, it indicates that the feature interaction item is to be deleted. If a value of an optimized architecture parameter of a feature interaction item reaches the threshold, it indicates that the feature interaction item is to be retained (or selected).

The threshold may be determined based on an actual application requirement. For example, a value of the threshold may be obtained through model training. A manner of obtaining the threshold is not limited in this disclosure.

Optionally, in another implementation, if values of some architecture parameters change to zero after optimization is completed, feature interaction items corresponding to the optimized architecture parameters whose values are not zero may be directly used as retained feature interaction items, to obtain the third model.

Optionally, in still another implementation, if values of some architecture parameters change to zero after optimization is completed, a feature interaction item corresponding to an architecture parameter whose value is less than the threshold may be further deleted from feature interaction items corresponding to the optimized architecture parameters whose values are not zero, to obtain the third model.

In an existing automatic FIS solution, all possible feature interaction subsets are used as search space, and a best candidate subset is selected from n randomly selected candidate subsets by using a discrete algorithm as a selected feature interaction. Training needs to be performed once for evaluating each candidate subset, resulting in a large computing workload and high computing power consumption.

In this disclosure, the architecture parameters are introduced into the FM-based model, so that feature interaction item selection can be performed through optimization on the architecture parameters. In other words, in this disclosure, provided that optimization on the architecture parameters is performed once, feature interaction item selection can be performed, and training for a plurality of candidate subsets in a conventional technology is not required. Therefore, this can effectively reduce a computing workload of FIS to save computing power, and improve efficiency of FIS.

In addition, an existing automatic FIS solution cannot be applied to a deep learning model with a long training period, because of the large computing workload and high computing power consumption.

In this disclosure, FIS can be performed through an optimization process of the architecture parameters. Alternatively, feature interaction item selection can be completed through one end-to-end model training process, so that a period for feature interaction item selection (or search) may be equivalent to a period for one model training. Therefore, FIS can be applied to a deep learning model with a long training period.

In the FM model in the conventional technology, because all feature interactions need to be enumerated, it is difficult to extend to a higher order.

In this disclosure, the architecture parameters are introduced into the FM-based model, so that FIS can be performed through optimization on the architecture parameters. Therefore, in the solution of this disclosure, the feature interaction item in the FM-based model can be extended to a higher order.

Optimization may be performed on the architecture parameters in the second model by using a plurality of optimization algorithms (or optimizers).

With reference to the first aspect, in a possible implementation of the first aspect, optimization allows the optimized architecture parameters to be sparse.

In this disclosure, optimization on the architecture parameters allows the architecture parameters to be sparse, facilitating subsequent feature interaction item deletion.

Optionally, in an implementation in which optimization allows the optimized architecture parameters to be sparse, obtaining, based on the optimized architecture parameters and the first model or the second model, a third model through feature interaction item deletion includes obtaining, based on the first model or the second model, the third model by deleting a feature interaction item corresponding to an architecture parameter in the optimized architecture parameters whose value is less than a threshold.

In an implementation, in the first model, the third model is obtained by deleting a feature interaction item corresponding to an architecture parameter in the optimized architecture parameters whose value is less than a threshold.

In another implementation, in the second model, the third model is obtained by deleting a feature interaction item corresponding to an architecture parameter in the optimized architecture parameters whose value is less than a threshold.

It should be understood that the third model is obtained through feature interaction item deletion based on the second model, so that the third model has the optimized architecture parameters that represent importance of the feature interaction items. Subsequently, importance of the feature interaction items can be further learned through training of the third model.

With reference to the first aspect, in a possible implementation of the first aspect, optimization allows a value of an architecture parameter of at least one feature interaction item to be equal to zero after optimization is completed.

It is assumed that a feature interaction item corresponding to an architecture parameter whose value is zero after optimization is completed is considered as an unimportant feature interaction item. That optimization allows a value of an architecture parameter of at least one feature interaction item to be equal to zero after optimization is completed may be considered as allowing the value of the architecture parameter of the unimportant feature interaction item to be equal to zero after optimization is completed.

Optionally, optimization is performed on the architecture parameters in the second model using a generalized regularized dual averaging (gRDA) optimizer, where the gRDA optimizer allows the value of the architecture parameter of the at least one feature interaction item to tend to zero during an optimization process.

In embodiments of this disclosure, optimization on the architecture parameters allows some architecture parameters to tend to zero, which is equivalent to removing some unimportant feature interaction items in an architecture parameter optimization process. In other words, optimization on the architecture parameters implements architecture parameter optimization and feature interaction item selection. This can improve efficiency of FIS and reduce a computing workload and computing power consumption.

In addition, in the architecture parameter optimization process, removing some unimportant feature interaction items can prevent noise generated by these unimportant feature interaction items. In this case, a model gradually evolves into an ideal model in the architecture parameter optimization process. In addition, prediction of other parameters (for example, architecture parameters and model parameters of an unremoved feature interaction item) in the model can be more accurate.

Optionally, in an implementation in which optimization allows the optimized architecture parameters to be sparse and allows a value of an architecture parameter of at least one feature interaction item to be equal to zero after optimization is completed, obtaining, based on the optimized architecture parameters and the first model or the second model, a third model through feature interaction item deletion includes obtaining the third model by deleting a feature interaction item other than feature interaction items corresponding to the optimized architecture parameters.

Optionally, in the first model, the third model is obtained by deleting the feature interaction item other than the feature interaction items corresponding to the optimized architecture parameters. In other words, the third model is obtained through feature interaction item deletion based on the first model.

Optionally, the second model obtained through architecture parameter optimization is used as the third model. In other words, the third model is obtained through feature interaction item deletion based on the second model.

It should be understood that the third model is obtained through feature interaction item deletion based on the second model, so that the third model has the optimized architecture parameters that represent importance of the feature interaction items. Subsequently, importance of the feature interaction items can be further learned through training of the third model.

Optionally, in an implementation in which optimization allows the optimized architecture parameters to be sparse and allows a value of an architecture parameter of at least one feature interaction item to be equal to zero after optimization is completed, obtaining, based on the optimized architecture parameters and the first model or the second model, a third model through feature interaction item deletion includes obtaining the third model by deleting a feature interaction item other than feature interaction items corresponding to the optimized architecture parameters and deleting the feature interaction item corresponding to the architecture parameter in the optimized architecture parameters whose value is less than the threshold.

Optionally, in the first model, the third model is obtained by deleting the feature interaction item other than the feature interaction items corresponding to the optimized architecture parameters and deleting the feature interaction item corresponding to the architecture parameter in the optimized architecture parameters whose value is less than the threshold.

Optionally, in the second model obtained through architecture parameter optimization, the third model is obtained by deleting a feature interaction item corresponding to an architecture parameter in the optimized architecture parameters whose value is less than a threshold.

It should be understood that the third model is obtained through feature interaction item deletion based on the second model, so that the third model has the optimized architecture parameters that represent importance of the feature interaction items. Subsequently, importance of the feature interaction items can be further learned through training of the third model.

With reference to the first aspect, in a possible implementation of the first aspect, the method further includes performing optimization on model parameters in the second model, where optimization includes scalarization processing on the model parameters in the second model.

The model parameters indicate weight parameters other than the architecture parameters of the feature interaction item in the second model. In other words, the model parameters represent an original parameter in the first model.

In an implementation, optimization includes performing batch normalization (BN) processing on the model parameters in the second model.

It should be understood that scalarization processing is performed on the model parameters of the feature interaction item, to decouple the model parameters from the architecture parameters of the feature interaction item. In this case, the architecture parameters can more accurately reflect importance of the feature interaction items, further improving optimization accuracy of the architecture parameters.

With reference to the first aspect, in a possible implementation of the first aspect, performing optimization on architecture parameters in the second model and the performing optimization on model parameters in the second model include performing simultaneous optimization on both the architecture parameters and the model parameters in the second model by using same training data, to obtain the optimized architecture parameters.

In other words, in each round of training in an optimization process, simultaneous optimization is performed on both the architecture parameters and the model parameters based on a same batch of training data.

Alternatively, the architecture parameters and the model parameters in the second model are considered as decision variables at a same level, and simultaneous optimization is performed on both the architecture parameters and the model parameters in the second model, to obtain the optimized architecture parameters.

In this disclosure, one-level optimization processing is performed on the architecture parameters and the model parameters in the second model, to implement optimization on the architecture parameters in the second model, so that simultaneous optimization can be performed on the architecture parameters and the model parameters. Therefore, time consumed in an optimization process of the architecture parameters in the second model can be reduced, to further help improve efficiency of feature interaction item selection.

With reference to the first aspect, in a possible implementation of the first aspect, the method further includes training the third model to obtain a CTR prediction model or a conversion rate (CVR) prediction model.

According to a second aspect, a data processing method is provided. The method includes inputting data of a target object into a CTR prediction model or a CVR prediction model, to obtain a prediction result of the target object, and determining a recommendation status of the target object based on the prediction result of the target object.

The CTR prediction model or the CVR prediction model is obtained through the method in the first aspect.

Training of a third model includes the following step: train the third model by using a training sample of the target object, to obtain the CTR prediction model or the CVR prediction model.

Optionally, optimization on architecture parameters includes the following step: perform simultaneous optimization on both the architecture parameters and model parameters in a second model by using the same training data as that in the training sample of the target object, to obtain the optimized architecture parameters.

According to a third aspect, a data processing apparatus is provided. The apparatus includes the following units.

A first processing unit is configured to add an architecture parameter to each feature interaction item in a first model, to obtain a second model, where the first model is an FM-based model, and the architecture parameter represents importance of a corresponding feature interaction item.

A second processing unit is configured to perform optimization on architecture parameters in the second model, to obtain the optimized architecture parameters.

A third processing unit is configured to obtain, based on the optimized architecture parameters and the first model or the second model, a third model through feature interaction item deletion.

With reference to the third aspect, in a possible implementation of the third aspect, the second processing unit performs optimization on the architecture parameters, to allow the optimized architecture parameters to be sparse.

With reference to the third aspect, in a possible implementation of the third aspect, the third processing unit is configured to obtain, based on the first model or the second model, the third model by deleting a feature interaction item corresponding to an architecture parameter in the optimized architecture parameters whose value is less than a threshold.

With reference to the third aspect, in a possible implementation of the third aspect, the second processing unit performs optimization on the architecture parameters, to allow a value of an architecture parameter of at least one feature interaction item to be equal to zero after optimization is completed.

With reference to the third aspect, in a possible implementation of the third aspect, the third processing unit is configured to optimize the architecture parameters in the second model using a gRDA optimizer, where the gRDA optimizer allows the value of the architecture parameter of the at least one feature interaction item to tend to zero during an optimization process.

With reference to the third aspect, in a possible implementation of the third aspect, the second processing unit is further configured to perform optimization on model parameters in the second model, where optimization includes scalarization processing on the model parameters in the second model.

With reference to the third aspect, in a possible implementation of the third aspect, the second processing unit is configured to perform BN processing on the model parameters in the second model.

With reference to the third aspect, in a possible implementation of the third aspect, the second processing unit is configured to perform simultaneous optimization on both the architecture parameters and model parameters in a second model by using same training data, to obtain the optimized architecture parameters.

With reference to the third aspect, in a possible implementation of the third aspect, the apparatus further includes a training unit configured to train the third model, to obtain a CTR prediction model or a CVR prediction model.

According to a fourth aspect, a data processing apparatus is provided. The apparatus includes the following units.

A first processing unit is configured to input data of a target object into a CTR prediction model or a CVR prediction model, to obtain a prediction result of the target object.

A first processing unit is configured to determine a recommendation status of the target object based on the prediction result of the target object.

The CTR prediction model or the CVR prediction model is obtained through the method in the first aspect.

Training of a third model includes the following step: train the third model by using a training sample of the target object, to obtain the CTR prediction model or the CVR prediction model.

Optionally, optimization on architecture parameters includes the following step: perform simultaneous optimization on both the architecture parameters and model parameters in a second model by using the same training data as that in the training sample of the target object, to obtain the optimized architecture parameters.

According to a fifth aspect, an image processing apparatus is provided. The apparatus includes a memory configured to store a program, and a processor configured to execute the program stored in the memory, where when the program stored in the memory is being executed, the processor is configured to perform the method in the first aspect or the second aspect.

According to a sixth aspect, a computer-readable medium is provided. The computer-readable medium stores program code to be executed by a device, and the program code is used to perform the method in the first aspect or the second aspect.

According to a seventh aspect, a computer program product including instructions is provided. When the computer program product runs on a computer, the computer is enabled to perform the method in the first aspect or the second aspect.

According to an eighth aspect, a chip is provided. The chip includes a processor and a data interface. The processor reads, through the data interface, instructions stored in a memory, to perform the method in the first aspect or the second aspect.

Optionally, in an implementation, the chip may further include a memory and the memory stores instructions, the processor is configured to execute the instructions stored in the memory, and when the instructions are executed, the processor is configured to perform the methods in the first aspect or the second aspect.

According to a ninth aspect, an electronic device is provided. The electronic device includes the apparatus provided in the third aspect, the fourth aspect, the fifth aspect, or the sixth aspect.

It can be learned from the foregoing description that, in this disclosure, the architecture parameters are introduced into the FM-based model, so that feature interaction item selection can be performed through optimization on the architecture parameters. In other words, in this disclosure, feature interaction item selection can be performed through optimization on the architecture parameters, and training for a plurality of candidate subsets in the conventional technology is not required. Therefore, this can effectively reduce a computing workload of FIS to save computing power, and improve efficiency of FIS.

In addition, in the solution provided in this disclosure, the feature interaction item in the FM-based model can be extended to a higher order.

### BRIEF DESCRIPTION OF DRAWINGS

FIG. 1 is a schematic diagram of an FM model architecture;

FIG. 2 is a schematic diagram of FM model training;

FIG. 3 is a schematic flowchart of a data processing method according to an embodiment of this disclosure;

FIG. 4 is a schematic diagram of an FM model architecture according to an embodiment of this disclosure;

FIG. 5 is another schematic flowchart of a data processing method according to an embodiment of this disclosure;

FIG. 6 is still another schematic flowchart of a data processing method according to an embodiment of this disclosure;

FIG. 7 is a schematic block diagram of a data processing apparatus according to an embodiment of this disclosure;

FIG. 8 is another schematic block diagram of a data processing apparatus according to an embodiment of this disclosure;

FIG. 9 is still another schematic block diagram of a data processing apparatus according to an embodiment of this disclosure; and

FIG. 10 is a schematic diagram of a hardware architecture of a chip according to an embodiment of this disclosure.

### DESCRIPTION OF EMBODIMENTS

The following describes technical solutions of this disclosure with reference to accompanying drawings.

With rapid development of current technologies, there is an increasing amount of data. To solve an information overload problem, a recommender system (recommender system, RS) is proposed. The recommender system sends historical behavior, interests, preferences, or demographic features of a user to a recommendation algorithm, and then uses the recommendation algorithm to generate a list of items that the user may be interested in.

In the recommender system, CTR prediction (or further including CVR prediction) is a very important step. Whether to recommend a commodity needs to be determined based on a predicted CTR. In addition to a single feature, a feature interaction also needs to be considered during CTR prediction. The feature interaction is very important for recommendation ranking. An FM can reflect the feature interaction. The FM may be referred to as an FM model.

Based on a maximum order of the feature interaction item, the FM model may be referred to as a *-order FM model. For example, an FM model whose feature interaction item has a maximum of a second order may be referred to as a second-order FM model, and an FM model whose feature interaction item has a maximum of a third order may be referred to as a third-order FM model.

An order of the feature interaction item indicates a specific quantity of features corresponding to the feature interaction item. For example, an interaction item of two features may be referred to as a second-order feature interaction item, and an interaction item of three features may be referred to as a third-order feature interaction item.

In an example, the second-order FM model is shown in the following formula (1):

$$\hat{y} ( x ) := {w}_{0} + {{Σ}_{i = 1}}^{m} {w}_{i} {x}_{i} + {{Σ}_{i = 1}}^{m} {\sum }_{j = i + 1}^{m} 〈 {v}_{i} , {v}_{j} 〉 {x}_{i} {x}_{j} \qquad ( 1 )$$

$$〈 {v}_{i} , {v}_{j} 〉 := {\sum }_{f = 1}^{k} {v}_{i , f} \cdot {v}_{j , f} .$$

x indicates a feature vector, xᵢ indicates an i^{th} feature, and xⱼ indicates a j^{th} feature. m indicates a quantity of features, and may also be referred to as a feature field. w₀ indicates a global offset, and w₀∈R. wᵢ indicates strength of the ith feature, and w∈R^{m}. vᵢ indicates an auxiliary vector of the ith feature xᵢ. vⱼ indicates an auxiliary vector of the jth feature xⱼ. k is a quantity of [[ ]]vᵢ and vⱼ. A two-dimensional matrix v∈R^{m×k}.

xᵢxⱼ indicates a combination of the ith feature xᵢ and the jth feature xⱼ.

[symbol] vᵢ,vⱼ [symbol] indicates an inner product of vᵢ and vⱼ, and indicates interaction between the ith feature xᵢ and the jth feature xⱼ. [symbol] vᵢ,vⱼ [symbol] may also be understood as a weight parameter of a feature interaction item xᵢxⱼ, for example, [symbol] vᵢ,vⱼ [symbol] may be denoted as wᵢⱼ.

In this specification, [symbol] vᵢ,vⱼ [symbol] is denoted as a weight parameter of a feature interaction item xᵢxⱼ.

Optionally, the formula (1) may also be expressed as the following formula (2):

$${l}_{fm} = 〈 w , x 〉 + {\sum }_{i = 1}^{m} {\sum }_{j > 1}^{m} 〈 {e}_{i} , {e}_{j} 〉 . \qquad ( 2 )$$

In the formula (2), [symbol] eᵢ,eⱼ [symbol] indicates [symbol] vᵢ,vⱼ [symbol] xᵢxⱼ in the formula (1), and [symbol] w,x [symbol] indicates w₀+Σᵢ₌₁^{m}wᵢxᵢ in the formula (1).

[symbol]

In another example, the third-order FM model is shown in the following formula (3):

$${l}_{fm}^{3 rd} = 〈 w , x 〉 + {{Σ}_{i = 1}}^{m} {{Σ}_{j > i}}^{m} 〈 {e}_{i} , {e}_{j} 〉 + {{Σ}_{i = 1}}^{m} {{Σ}_{j > i}}^{m} {{Σ}_{t > j}}^{m} 〈 {e}_{i} , {e}_{j} , {e}_{t} 〉 . \qquad ( 3 )$$

The FM model includes feature interaction items of all interactions of single features. For example, a second-order FM model shown in the formula (1) or the formula (2) includes feature interaction items of all second-order feature interactions of single features. For another example, the third-order FM model shown in the formula (3) includes feature interaction items of all second-order feature interactions of single features and feature interaction items of all third-order feature interactions of single features.

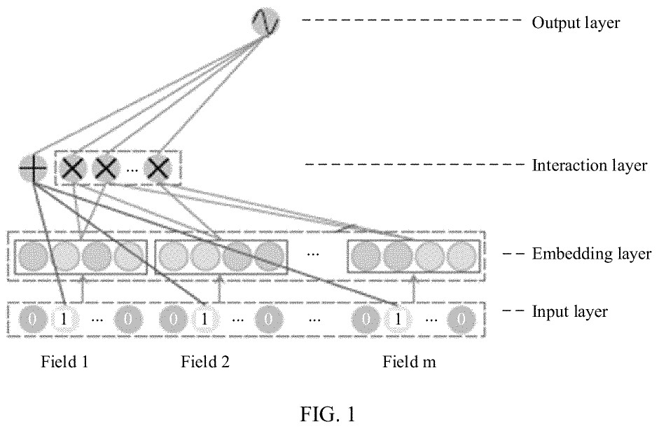

For example, in the industry, an operation of obtaining an auxiliary vector vᵢ of a feature xᵢ is referred to as embedding, and an operation of building a feature interaction item based on the feature xᵢ and the auxiliary vector vᵢ thereof is referred to as interaction. FIG. 1 is a schematic diagram of an FM model architecture. As shown in FIG. 1, an FM model may be considered as a neural network model, and includes an input layer, an embedding layer, an interaction layer, and an output layer. The input layer is used to generate a feature. A field 1, a field, . . . , and a field m indicate a quantity of features. The embedding layer is used to generate an auxiliary vector of the feature. The interaction layer is used to generate a feature interaction item based on the feature and the auxiliary vector of the feature. The output layer is used to output the FM model.

In the conventional technology, CTR prediction or CVR prediction is usually based on an FM.

In the current technology, an FM-based model includes an FM model, a DeepFM model, an IPNN model, an AFM model, an NFM model, and the like.

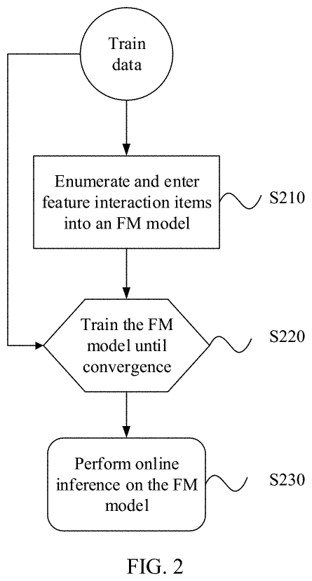

As an example instead of a limitation, a procedure of building an FM model is shown in FIG. 2.

S210: Enumerate and enter feature interaction items into the FM model.

For example, the FM model is built by using the formula (1) or the formula (3).

S220: Train the FM model until convergence, to obtain an FM model that can be put into use.

After FM model training is completed, online inference may be performed by using the trained FM model, as shown in step S230 in FIG. 2.

As described above, the FM model includes the feature interaction items of all interactions of single features. Therefore, FM model training has an extremely large computing workload and consumes a lot of time.

In addition, it can be learned from the formula (1) and the formula (3) that a quantity of feature interaction items in the FM model increases sharply with increases in the quantity of features and an order of feature interaction.

For example, in the formula (1), as the quantity m of features increases, the quantity of feature interaction items increases exponentially. For another example, as the order of feature interaction increases in a switch from a second-order FM model to a third-order FM model, the quantity of feature interaction items in the FM model increases greatly.

Therefore, increases in the quantity of features and the order of feature interaction results in a huge burden to an inference delay and a computing workload of the FM model. Therefore, a maximum quantity of features and the order of feature interaction that can be accommodated by the FM model are limited. For example, it is difficult to extend the FM model in the current technology to a higher order.

To resolve this problem, FIS is proposed.

In some conventional technologies, FIS is performed in a manual selection manner. To select good feature interactions may take many years of exploration by engineers. This manual selection manner consumes a large amount of manpower, and may miss an important feature interaction item.

To address a disadvantage of manual selection, an AutoFIS solution is proposed in the industry. Compared with manual selection, valuable feature interactions can be selected through automatic FIS in a short period of time.

In the current technology, an automatic FIS solution is proposed. In the solution, all possible feature interaction subsets are used as search space, and a best candidate subset is selected from n randomly selected candidate subsets by using a discrete algorithm as a selected feature interaction. Training needs to be performed once for evaluating each candidate subset, resulting in a large computing workload and high computing power consumption. In addition, when each candidate subset is evaluated, entire model training can improve evaluation accuracy, but may cause huge search energy consumption (search cost), mini-batch training that is used for approximation may result in inaccurate evaluation. In addition, in this solution, as the order of the feature interaction increases, the search space increases exponentially, which increases energy consumption in a search process.

Therefore, the existing automatic FIS solution has a large computing workload, high energy consumption in a search process, and high computing power consumption.

For the foregoing problem, this disclosure provides an automatic FIS solution. Compared with the conventional technology, this solution can reduce computing power consumption of automatic FIS, and improve efficiency of automatic FIS.

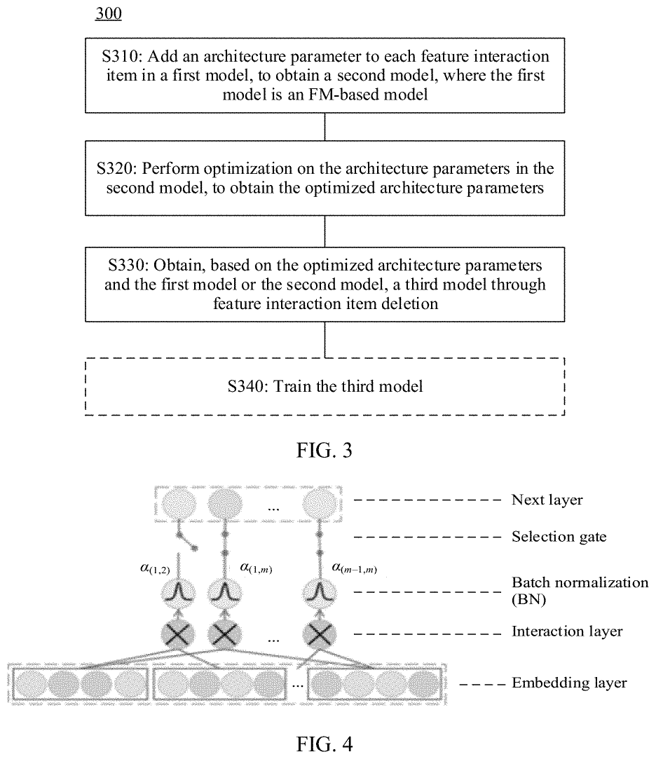

FIG. 3 is a schematic flowchart of a data processing method 300 according to an embodiment of this disclosure. The method 300 includes the following steps: S310, S320, and S330.

S310: Add an architecture parameter to each feature interaction item in a first model, to obtain a second model.

The first model is a model based on an FM. In other words, the first model includes feature interaction items of all interactions of single features, or the first model enumerates feature interaction items of all interactions.

For example, the first model may be any one of the following FM-based models: an FM model, a DeepFM model, an IPNN model, an AFM model, and an NFM model.

As an example, the first model is a second-order FM model shown in the formula (1) or the formula (2), or the first model is a third-order FM model shown in the formula (3).

In this disclosure, feature interaction item selection is performed, and the first model may be considered as a model on which a feature interaction item is to be deleted.

Adding an architecture parameter to each feature interaction item in the first model means adding a coefficient to each feature interaction item in the first model. In this disclosure, the coefficient is referred to as an architecture parameter. The architecture parameter represents importance of a corresponding feature interaction item. A model obtained by adding the architecture parameter each feature interaction item in the first model is denoted as a second model.

In an example, assuming that the first model is a second-order FM model shown in the formula (1), the second model is shown in the following formula (4):

$$\hat{y} ( x ) := {w}_{0} + {{Σ}_{i = 1}}^{m} {w}_{i} {x}_{i} + {{Σ}_{i = 1}}^{m} {\sum }_{j = i + 1}^{m} {α}_{( i , j )} 〈 {v}_{i} , {v}_{j} 〉 {x}_{i} {x}_{j} \qquad ( 4 )$$

$$〈 {v}_{i} , {v}_{j} 〉 := {\sum }_{f = 1}^{k} {v}_{i , f} \cdot {v}_{j , f} .$$

x indicates a feature vector, xᵢ indicates an ith feature, and xⱼ indicates a jth feature. m indicates a feature dimension, and may also be referred to as a feature field. w₀ indicates a global offset, and w₀∈R. wᵢ indicates strength of the ith feature, and w∈R^{m}. vᵢ indicates an auxiliary vector of the ith feature xᵢ. vⱼ indicates an auxiliary vector of the jth feature xⱼ. k is a quantity of [[ ]]vᵢ and vⱼ. A two-dimensional matrix vϵR^{m×k}.

xᵢxⱼ indicates a combination of the ith feature xᵢ and the jth feature xⱼ.

[symbol] vᵢ,vⱼ [symbol] indicates a weight parameter of a feature interaction item xᵢxⱼ, and α(i,j) indicates an architecture parameter of the feature interaction item xᵢxⱼ.

[symbol] vᵢ,vⱼ [symbol] indicates an inner product of vᵢ and vⱼ, and indicates interaction between the ith feature xᵢ and the jth feature xⱼ. [symbol] vᵢ,vⱼ [symbol] may also be understood as a weight parameter of a feature interaction item, for example, [symbol] vᵢ,vⱼ [symbol] may be denoted as wᵢⱼ.

Assuming that the first model is expressed as the second-order FM model shown in the formula (2), the second model may be expressed as the following formula (5):

$${l}_{autoFIS} = 〈 w , x 〉 + {\sum }_{i = 1}^{m} {\sum }_{j > 1}^{m} {α}_{( i , j )} 〈 {e}_{i} , {e}_{j} 〉 . \qquad ( 5 )$$

α_{(i,j)} indicates an architecture parameter of a feature interaction item.

In another example, if the first model is a third-order FM model shown in the formula (3), the second model is shown in the following formula (6):

$${l}_{autoFIS} = 〈 w , x 〉 + {\sum }_{i = 1}^{m} {\sum }_{j > 1}^{m} {α}_{( i , j )} 〈 {e}_{i} , {e}_{j} 〉 + {{Σ}_{i = 1}}^{m} {{Σ}_{j > i}}^{m} {{Σ}_{t > j}}^{m} {α}_{( i , j , t )} 〈 {e}_{i} , {e}_{j} , {e}_{t} 〉 . \qquad ( 6 )$$

α_{(i,j)} and α_{(i,j,t)} indicate architecture parameters of feature interaction items.

For ease of understanding and description, the following is agreed in this specification. An original weight parameter (for example, [symbol] vᵢ,vⱼ [symbol] in the formula (4)) of the feature interaction [symbol] item in the first model is referred to as a model parameter.

In other words, in the second model, each feature interaction item has two types of coefficient parameters: a model parameter and an architecture parameter.

FIG. 4 is a schematic diagram of feature interaction item selection according to an embodiment of this disclosure. An embedding layer and an interaction layer in FIG. 4 have the same meanings as those of the embedding layer and the interaction layer in FIG. 1. As shown in FIG. 4, in this embodiment of this disclosure, architecture parameters α_{(i,j)} (α_{(1,2)}, α_{(1,m)}, and α_{(m-1,m)} shown in FIG. 4) are added to feature interaction items at the interaction layer. The interaction layer in FIG. 4 may be considered as a first model, and the interaction layer to which the architecture parameters α_{(i,j)} are added to the feature interaction items may be considered as a second model.

S320: Perform optimization on architecture parameters in the second model, to obtain the optimized architecture parameters.

For example, optimization is performed on the architecture parameters in the second model by using training data, to obtain the optimized architecture parameters.

For example, the optimized architecture parameters may be considered as optimal values α* of the architecture parameters in the second model.

In embodiments of this disclosure, the architecture parameter represents importance of a corresponding feature interaction item. Therefore, optimization on the architecture parameter is equivalent to learning importance of each feature interaction item or a contribution degree of each feature interaction item to model prediction. In other words, the optimized architecture parameter represents importance of the learned feature interaction item.

In other words, in embodiments of this disclosure, contribution (or importance) of each feature interaction item may be learned by using the architecture parameters in an end-to-end manner.

S330: Obtain, based on the optimized architecture parameters and the first model or the second model, a third model through feature interaction item deletion.

The third model may be a model obtained through feature interaction item deletion based on the first model.

Alternatively, the third model may be a model obtained through feature interaction item deletion based on the second model.

A feature interaction item to be deleted or retained (or selected) may be determined in a plurality of manners.

Optionally, in an implementation, a feature interaction item corresponding to an architecture parameter in the optimized architecture parameters whose value is less than a threshold may be deleted.

The threshold represents a criterion for determining whether to retain a feature interaction item. For example, if a value of an optimized architecture parameter of a feature interaction item is less than the threshold, it indicates that the feature interaction item is to be deleted. If a value of an optimized architecture parameter of a feature interaction item reaches the threshold, it indicates that the feature interaction item is to be retained (or selected).

The threshold may be determined based on an actual application requirement. For example, a value of the threshold may be obtained through model training. A manner of obtaining the threshold is not limited in this disclosure.

Still refer to FIG. 4. Assuming that the optimized architecture parameter α_{(1,2)} is less than the threshold, a feature interaction item corresponding to the architecture parameter α_{(1,2)} may be deleted. Assuming that the optimized architecture parameter α_{(1,m)} reaches the threshold, a feature interaction item corresponding to the architecture parameter α_{(1,m)} may be retained. A next-layer model is obtained by deleting the feature interaction item based on the optimized architecture parameter, as shown in FIG. 4. The third model in the embodiment in FIG. 3 is, for example, the next-layer model shown in FIG. 4.

As an example, instead of a limitation, as shown in FIG. 4, an operation of determining, based on the optimized architecture parameter, whether to delete a corresponding feature interaction item may be denoted as a selection gate.

It should be noted that FIG. 4 is merely an example rather than a limitation.

Optionally, in another implementation, if values of some architecture parameters change to zero after optimization is completed, feature interaction items corresponding to the optimized architecture parameters whose values are not zero may be directly used as retained feature interaction items, to obtain the third model.

Optionally, in still another implementation, if values of some architecture parameters change to zero after optimization is completed, a feature interaction item corresponding to an architecture parameter whose value is less than the threshold may be further deleted from feature interaction items corresponding to the optimized architecture parameters whose values are not zero, to obtain the third model.

In this specification, a “model obtained through feature interaction item deletion” can be replaced with a “model obtained through feature interaction item selection”.

As described above, in an existing automatic FIS solution, all possible feature interaction subsets are used as search space, and a best candidate subset is selected from n randomly selected candidate subsets by using a discrete algorithm as a selected feature interaction. Training needs to be performed once for evaluating each candidate subset, resulting in a large computing workload and high computing power consumption.

In embodiments of this disclosure, the architecture parameters are introduced into the FM-based model, so that feature interaction item selection can be performed through optimization on the architecture parameters. In other words, in this disclosure, provided that optimization on the architecture parameters is performed once, feature interaction item selection can be performed, and training for a plurality of candidate subsets in a conventional technology is not required. Therefore, this can effectively reduce a computing workload of FIS to save computing power, and improve efficiency of FIS.

In addition, in an existing automatic FIS solution, FIS is performed by searching for a candidate subset in search space. It may be understood that, in the conventional technology, FIS is resolved as a discrete issue, in other words, a discrete feature interaction candidate set is searched for.

In this embodiment of this disclosure, FIS is performed through optimization on the architecture parameters that are introduced into the FM-based model. It may be understood that, in this embodiment of this disclosure, an existing problem of searching for the discrete feature interaction candidate set is continuous, in other words, FIS is resolved as a continuous issue. For example, the automatic FIS solution provided in this disclosure may be expressed as a feature interaction search solution based on continuous search space. In other words, in this embodiment of this disclosure, an operation of introducing the architecture parameters into the FM-based model may be considered as continuous modeling for automatic feature interaction item selection.

In addition, an existing automatic FIS solution cannot be applied to a deep learning model with a long training period, because of the large computing workload and high computing power consumption.

In embodiments of this disclosure, FIS can be performed through an optimization process of the architecture parameters. Alternatively, feature interaction item selection can be completed through one end-to-end model training process, so that a period for feature interaction item selection (or search) may be equivalent to a period for one model training. Therefore, FIS can be applied to a deep learning model with a long training period.

As described above, in the FM model in the conventional technology, because all feature interactions need to be enumerated, it is difficult to extend to a higher order.

In embodiments of this disclosure, the architecture parameters are introduced into the FM-based model, so that FIS can be performed through optimization on the architecture parameters. Therefore, in the solution provided in embodiments of this disclosure, the feature interaction item in the FM-based model can be extended to a higher order.

For example, an FM model built by using the solution provided in embodiments of this disclosure may be extended to a third order or a higher order.

For another example, the DeepFM model built by using the solution provided in this embodiment of this disclosure may be extended to a third order or a higher order.

In embodiments of this disclosure, the architecture parameters are introduced into the conventional FM-based model, so that FIS can be performed through optimization on the architecture parameters. In other words, in embodiments of this disclosure, the FM-based model that includes the architecture parameters is built, and FIS can be performed by performing optimization on the architecture parameters. A method for building the FM-based model that includes the architecture parameters is adding the architecture parameter before each feature interaction item in the conventional FM-based model.

As shown in FIG. 3, the method 300 may include step S340.

S340: Train the third model.

Step S340 may also be understood as performing model training again. It may be understood that the feature interaction item is deleted by using step S310, step S320, and step S330. In step S340, the model obtained through feature interaction item deletion is retrained.

In step S340, the third model may be directly trained, or the third model may be trained after a L1 regular term and/or a L2 regular term are/is added to the third model.

For example, an objective of training the third model may be determined based on an application requirement.

For example, assuming that a CTR prediction model is to be obtained, the third model is trained by using the obtained CTR prediction model as the training objective, to obtain the CTR prediction model.

For another example, assuming that a CVR prediction model is to be obtained, the third model is trained by using the conversion rate, CVR prediction model as the training objective, to obtain the CVR prediction model.

In step S320, for example, optimization may be performed on the architecture parameters in the second model by using a plurality of optimization algorithms (or optimizers).

A first optimization algorithm:

Optionally, in step S320, optimization is performed on the architecture parameters, to allow the optimized architecture parameters to be sparse.

For example, in step S320, optimization is performed on the architecture parameters in the second model by using least absolute shrinkage and selection operator (Lasso) regularization.

That the formula (5) is used in the second model is used as an example. In step S320, the architecture parameters in the second model are optimized by using the following formula (7):

$${L}_{search} = {L}_{α , w} ( y , {\hat{y}}_{M} ) + λ {\sum }_{i , j > i} \vert {α}_{( i , j )} \vert . \qquad ( 7 )$$

L_{α,w}(y,ŷ_{M}) indicates a loss function. y indicates a model observed value. ŷ_{M} indicates a model predicted value. λ indicates a constant, and its value may be assigned based on a specific requirement.

It should be understood that the formula (7) indicates a constraint condition for architecture parameter optimization.

The optimized architecture parameters are sparse, facilitating subsequent feature interaction item deletion.

Optionally, in an embodiment, in step S320, optimization on the architecture parameters allows the optimized architecture parameters to be sparse, in step S330, the third model is obtained, based on the first model or the second model, by deleting a feature interaction item corresponding to an architecture parameter in the optimized architecture parameters whose value is less than a threshold.

The threshold represents a criterion for determining whether to retain a feature interaction item. For example, if a value of an optimized architecture parameter of a feature interaction item is less than the threshold, it indicates that the feature interaction item is to be deleted. If a value of an optimized architecture parameter of a feature interaction item reaches the threshold, it indicates that the feature interaction item is to be retained (or selected).

The threshold may be determined based on an actual application requirement. For example, a value of the threshold may be obtained through model training. A manner of obtaining the threshold is not limited in this disclosure.

In embodiments of this disclosure, optimization on the architecture parameters allows the architecture parameters to be sparse, facilitating feature interaction item selection.

It should be understood that the architecture parameters in the second model represent importance or a contribution degree of a corresponding feature interaction. If a value of an optimized architecture parameter is less than the threshold, for example, close to zero, it indicates that a feature interaction item corresponding to the architecture parameter is not important or has a very low contribution degree. Deleting (or referred to as removing or cutting) such feature interaction item can remove noise introduced by the feature interaction item, reduce energy consumption, and improve an inference speed of a model.

Therefore, deleting the feature interaction item corresponding to the architecture parameter in the optimized architecture parameters whose value is less than the threshold is an appropriate FIS operation.

A second optimization algorithm:

Optionally, in step S320, optimization is performed on the architecture parameters, so that the optimized architecture parameters are sparse and a value of an architecture parameter of at least one feature interaction item is equal to zero after optimization is completed.

It is assumed that the feature interaction item corresponding to the architecture parameter whose value is zero after optimization is completed is considered as an unimportant feature interaction item. Optimization on the architecture parameters in step S320 may be considered as allowing the value of the architecture parameter of the unimportant feature interaction item to be equal to zero after optimization is completed.

In other words, optimization on the architecture parameters allows the value of the architecture parameter of the at least one feature interaction item to tend to zero during an optimization process.

For example, in step S320, the architecture parameters in the second model are optimized using a gRDA optimizer. The gRDA optimizer allows the architecture parameters to be sparse, and allows the value of the architecture parameter of the at least one feature interaction item to gradually tend to zero during an optimization process.

For example, in step S320, the architecture parameters in the second model are optimized by using the following formula (8):

$${α}_{t + 1} = {arg min}_{α} \{ {α}^{T} ( - {α}_{0} + γ {\sum }_{i = 0}^{t} ∇ L ( {α}_{t} ; {y}_{i + 1} ) + g ( t , γ ) {‖ α ‖}_{1} + \frac{1}{2} {‖ α ‖}_{2}^{2} ) \} . \qquad ( 8 )$$

γ indicates a learning rate. yᵢ₊₁ indicates a model observation value. g(t,γ)=cγ^{1/2}(tγ)^{μ}. c and μ represent adjustable hyperparameters. An objective of adjusting c and μ is to find a balance between a model accuracy and sparseness of an architecture parameter α.

It should be understood that the formula (8) indicates a constraint condition for architecture parameter optimization.

It should be further understood that, in this embodiment, in step S320, the second model obtained through architecture parameter optimization is a model obtained through feature interaction item selection.

In this disclosure, optimization on the architecture parameters allows some architecture parameters to tend to zero, which is equivalent to removing some unimportant feature interaction items in an architecture parameter optimization process. In other words, optimization on the architecture parameters implements architecture parameter optimization and feature interaction item selection. This can improve efficiency of FIS and reduce a computing workload and computing power consumption.

In addition, in the architecture parameter optimization process, removing some unimportant feature interaction items can prevent noise generated by these unimportant feature interaction items. In this case, a model gradually evolves into an ideal model in the architecture parameter optimization process. In addition, prediction of other parameters (for example, architecture parameters and model parameters of an unremoved feature interaction item) in the model can be more accurate.

Optionally, in an embodiment, in step S320, optimization is performed on the architecture parameters, so that the optimized architecture parameters are sparse and a value of an architecture parameter of at least one feature interaction item is equal to zero after optimization is completed, in step S330, the third model may be obtained in the following plurality of manners.

Manner (1):

In step S330, feature interaction items corresponding to the optimized architecture parameters may be directly used as selected feature interaction items, and the third model is obtained based on the selected feature interaction items.

For example, in the first model, the feature interaction items corresponding to the optimized architecture parameters are used as the selected feature interaction items, and remaining feature interaction items are deleted, to obtain the third model.

For another example, a model obtained through architecture parameter optimization on the second model is directly used as the third model.

Manner (2):

In step S330, the feature interaction item corresponding to the architecture parameter in the optimized architecture parameters whose value is less than the threshold is deleted from feature interaction items corresponding to the optimized architecture parameters, to obtain the third model.

The threshold may be determined based on an actual application requirement. For example, a value of the threshold may be obtained through model training. A manner of obtaining the threshold is not limited in this disclosure.

For example, in the first model, the third model is obtained by deleting the feature interaction item other than the feature interaction items corresponding to the optimized architecture parameters and deleting the feature interaction item corresponding to the architecture parameter in the optimized architecture parameters whose value is less than the threshold.

For another example, in the second model obtained through architecture parameter optimization, the third model is obtained by deleting the feature interaction item corresponding to the architecture parameter in the optimized architecture parameters whose value is less than the threshold.

In embodiments of this disclosure, optimization on the architecture parameters allows some architecture parameters to tend to zero, which is equivalent to removing some unimportant feature interaction items in an architecture parameter optimization process. In other words, optimization on the architecture parameters implements architecture parameter optimization and feature interaction item selection. This can improve efficiency of FIS and reduce a computing workload and computing power consumption.

It can be learned from the foregoing description of step S320 that, in step S330, an implementation of obtaining the third model through feature interaction item selection may be determined based on an optimization manner of the architecture parameters in step S320. The following describes implementations of obtaining the third model in the following two cases.

In a first case, in step S320, optimization is performed on the architecture parameters, to allow the optimized architecture parameters to be sparse.

In step S330, the third model is obtained by deleting the feature interaction item corresponding to the architecture parameter in the optimized architecture parameters whose value is less than a threshold. For the threshold, refer to the foregoing description. Details are not described herein again.

As an example, instead of a limitation, optimized architecture parameters obtained through architecture parameter optimization (namely, optimization convergence) are denoted as optimal values α* of the architecture parameters. Based on the optimal values α*, specific feature interaction items that are to be retained or deleted are determined. For example, if an optimal value α*_{(i,j)} of an architecture parameter of a feature interaction item reaches the threshold, the feature interaction item should be retained, if an optimal value α*_{(i,j)} of an architecture parameter of a feature interaction item is less than the threshold, the feature interaction item should be deleted.

For example, in the second model, for each feature interaction item, a selection gate ψ_{(i,j)} indicating whether the feature interaction item is retained in a model is set. The second model may be expressed as the following formula (9):

$$\hat{y} ( x ) := {w}_{0} + {{Σ}_{i = 1}}^{m} {w}_{i} {x}_{i} + {{Σ}_{i = 1}}^{m} {\sum }_{j = i + 1}^{m} {α}_{( i , j )} {ψ}_{( i , j )} 〈 {v}_{i} , {v}_{j} 〉 {x}_{i} {x}_{j} . \qquad ( 9 )$$

A value of the switch item ψ_{(i,j)} may be represented by using the following formula (10):

$${ψ}_{( i , j )} = \{ \begin{matrix}1 & \vert {α}_{( i , j )}^{⋆} \vert \geq thr \\ 0 & \vert {α}_{( i , j )}^{⋆} \vert < thr\end{matrix} . \qquad ( 10 )$$

thr indicates a threshold.

A feature interaction item whose switch item ψ_{(i,j)} is 0 is deleted from the second model, to obtain the third model through feature interaction item selection.

In this embodiment, setting of the switch item ψ_{(i,j)} may be considered as a criterion for determining whether to retain a feature interaction item.

Alternatively, the third model may be a model obtained through feature interaction item deletion based on the first model.

For example, the feature interaction item whose switch item ψ_{(i,j)} is 0 is deleted from the first model, to obtain the third model through feature interaction item selection.

Alternatively, the third model may be a model obtained through feature interaction item deletion based on the second model.

For example, the feature interaction item whose switch item ψ_{(i,j)} is 0 is deleted from the second model, to obtain the third model through feature interaction item selection.

It should be understood that, in this embodiment, the third model has optimized architecture parameters that represent importance of feature interaction items. Subsequently, importance of the feature interaction items can be further learned through training of the third model.

In a second case, in step S320, optimization is performed on the architecture parameters, so that the optimized architecture parameters are sparse and a value of an architecture parameter of at least one feature interaction item is equal to zero after optimization is completed.

Optionally, in step S330, the third model is obtained by deleting the feature interaction item other than the feature interaction items corresponding to the optimized architecture parameters.

In an example, in step S330, the third model is obtained by deleting the feature interaction item other than the feature interaction items corresponding to the optimized architecture parameters in the first model. In other words, the third model is obtained through feature interaction item deletion based on the first model.

In another example, in step S330, the second model obtained through architecture parameter optimization is used as the third model. In other words, the third model is obtained through feature interaction item deletion based on the second model.

Optionally, in step S330, the third model is obtained by deleting the feature interaction item other than the feature interaction items corresponding to the optimized architecture parameters and deleting the feature interaction item corresponding to the architecture parameter in the optimized architecture parameters whose value is less than the threshold.

In an example, in step S330, the third model is obtained by deleting the feature interaction item other than the feature interaction items corresponding to the optimized architecture parameters and deleting the feature interaction item corresponding to the architecture parameter in the optimized architecture parameters whose value is less than the threshold in the first model. In other words, the third model is obtained through feature interaction item deletion based on the first model.

In another example, in step S330, in the second model obtained through architecture parameter optimization, the third model is obtained by deleting a feature interaction item corresponding to an architecture parameter in the optimized architecture parameters whose value is less than a threshold. In other words, the third model is obtained through feature interaction item deletion based on the second model.

It should be understood that, in an embodiment in which the third model is obtained through feature interaction item deletion based on the second model, the third model has the optimized architecture parameters that represent importance of the feature interaction items. Subsequently, importance of the feature interaction items can be further learned through training of the third model.

It may be understood from the formula (4), the formula (5), or the formula (6) that the second model includes two types of parameters: an architecture parameter and a model parameter. The model parameters indicate weight parameters other than the architecture parameters of the feature interaction item in the second model. For example, in an example of the second model expressed in the formula (4), α_{(i,j)} indicates architecture parameters of the feature interaction items, and [symbol] vᵢ, vⱼ [symbol] indicates model parameters of the feature interaction items. For example, in an example of the second model expressed in the formula (5), α_{(i,j)} indicates architecture parameters of the feature interaction items, and [symbol] eᵢ,eⱼ [symbol] may indicate model parameters of the feature interaction items.

It may be understood that, an architecture parameter optimization process involves architecture parameter training and model parameter training. In other words, optimization on the architecture parameters in the second model in step S320 is accompanied by optimization on the model parameters in the second model.

For example, in the embodiment shown in FIG. 3, the method 300 further includes performing optimization on model parameters in the second model, where optimization includes scalarization processing on the model parameters.

In each round of training in the model parameter optimization process, scalarization processing is performed on the model parameters in the second model.

For example, scalarization processing is performed on the model parameters in the second model by performing BN on the model parameters in the second model.

For example, in an example of the second model expressed in the formula (5), the architecture parameters in the second model are optimized by using the following formula (11):

$${〈 {e}_{i} , {e}_{j} 〉}_{B N} = \frac{{〈 {e}_{i} , {e}_{j} 〉}_{B} - {μ}_{B} ( {〈 {e}_{i} , {e}_{j} 〉}_{B} )}{\sqrt{{σ}_{B}^{2} ( {〈 {e}_{i} , {e}_{j} 〉}_{B} ) + θ}} . \qquad ( 11 )$$

[symbol] eᵢ,eⱼ [symbol] _{BN} indicates BN of [symbol] eᵢ, eⱼ [symbol] .

[symbol] eᵢ,eⱼ [symbol] _{B} indicates mini-batch data of [symbol] eᵢ,eⱼ [symbol] .

μ_{B}( [symbol] eᵢ,eⱼ [symbol] _{B}) indicates an average value of mini-batch data of [symbol] eᵢ,eⱼ [symbol] .

σ_{B}²( [symbol] eᵢ,eⱼ [symbol] _{B}) indicates a variance of mini-batch data of [symbol] eᵢ,eⱼ [symbol] .

θ indicates disturbance.

Still refer to FIG. 4. BN shown in FIG. 4 indicates BN processing on the model parameters in the second model.

Scalarization processing is performed on the model parameters of the feature interaction items, to decouple the model parameters from the architecture parameters of the feature interaction items. In this case, the architecture parameters can more accurately reflect importance of the feature interaction items, further improving optimization accuracy of the architecture parameters. This is explained as follows.

It should be understood that eᵢ is continuously updated and changed in a model training process. After inner product is performed on eᵢ and eⱼ, in other words, [symbol] eᵢ,eⱼ [symbol] , a scale of the inner product is constantly updated. It is assumed that α_{(i,j)} [symbol] eᵢ,eⱼ [symbol] may be obtained through

$$( \frac{{α}_{( i , j )}}{η} ) ( η \cdot 〈 {e}_{i} , {e}_{j} 〉 ) ,$$

where a first term

$$( \frac{{α}_{( i , j )}}{η} )$$

is coupled to a second term (n· [symbol] eᵢ,eⱼ [symbol] ). If the second item (n· [symbol] eᵢ,eⱼ [symbol] ) is not scalarized, the first item

$$( \frac{{α}_{( i , j )}}{η} )$$

cannot absolutely represent importance of the second item, causing great instability to a system.

In this embodiment of this disclosure, scalarization processing is performed on the model parameters of the feature interaction item, so that α_{(i,j)} [symbol] eᵢ,eⱼ [symbol] cannot be obtained through

$$( \frac{{α}_{( i , j )}}{η} ) ( η \cdot 〈 {e}_{i} , {e}_{j} 〉 ) ,$$

in other words, the model parameters of the feature interaction item can be decoupled from the architecture parameters.

The model parameters of the feature interaction item are decoupled from the architecture parameters, so that the architecture parameters can more accurately reflect importance of the feature interaction items, further improving optimization accuracy of the architecture parameters.

In other words, scalarization processing is performed on the model parameters of the feature interaction items, to decouple the model parameters from the architecture parameters of the feature interaction items, so that there is no coupling effect between the model parameters and the architecture parameters of the feature interaction items to cause large instability in the system.

As described above, the second model includes two types of parameters: the architecture parameters and the model parameters. An architecture parameter optimization process involves architecture parameter training and model parameter training. In other words, optimization on the architecture parameters in the second model in step S320 is accompanied by optimization on the model parameters in the second model.

For ease of understanding and description, in the following description, an architecture parameter in the second model is denoted as α, and a model parameter in the second model is denoted as w (corresponding to [symbol] vᵢ,vⱼ [symbol] in the formula (4)).

Optionally, in the embodiment shown in FIG. 3, optimization processing on the architecture parameter α in the second model and optimization processing on the model parameter w in the second model include two-level optimization processing on the architecture parameter α and the model parameter w in the second model.

In other words, in step S320, two-level optimization processing is performed on the architecture parameter α and the model parameter w in the second model, to obtain the optimized architecture parameter α*.

In this embodiment, the architecture parameter α in the second model is used as a model hyperparameter for optimization, and the model parameter w in the second model is used as a model parameter for optimization. In other words, the architecture parameter α is used as a high-level decision variable, and the model parameter w is used as a low-level decision variable. Any value of the high-level decision variable α corresponds to a different model.

Optionally, when a model corresponding to any value of the high-level decision variable α is evaluated, an optimal model parameter woptimal is obtained through entire training of the model. In other words, each time a candidate value of the architecture parameter α is evaluated, entire training of a model corresponding to the candidate value is performed.

Optionally, when a model corresponding to any value of the high-level decision variable α is evaluated, wt+1 obtained by updating the model in one step by using mini-batch data is used to replace the optimal model parameter woptimal.

Optionally, in the embodiment shown in FIG. 3, optimization processing on the architecture parameter α in the second model and optimization processing on the model parameter w in the second model include simultaneous optimization on both the architecture parameter α and the model parameter w in the second model by using same training data.

In other words, in step S320, simultaneous optimization processing is performed on both the architecture parameter α and the model parameter w in the second model, to obtain the optimized architecture parameter α* by using the same training data.

In this embodiment, in each round of training in an optimization process, simultaneous optimization is performed on both the architecture parameter α and the model parameter w based on a same batch of training data. Alternatively, the architecture parameter and the model parameter in the second model are considered as decision variables at a same level, and simultaneous optimization is performed on both the architecture parameter α and the model parameter w in the second model, to obtain the optimized architecture parameter α*.

In this embodiment, optimization processing performed on the architecture parameter α and the model parameter w in the second model may be referred to as one-level optimization processing.

For example, the architecture parameter α in the second model and the model parameter w freely explore their feasible fields in stochastic gradient descent (SGD) optimization until convergence.

For example, the architecture parameter α and the model parameter w in the second model are optimized by using the following formula (12):

αₜ=αₜ₋₁−ηₜ·∂_{α}Lₜᵣₐᵢₙ(wₜ₋₁,αₜ₋₁)

wₜ=wₜ₋₁−δₜ·∂_{w}Lₜᵣₐᵢₙ(wₜ₋₁,αₜ₋₁) (12).

αₜ indicates an architecture parameter after optimization in step t is performed. αₜ₋₁ indicates an architecture parameter after optimization in step t−1 is performed. wₜ indicates a model parameter after optimization in step t is performed. wₜ₋₁ indicates a model parameter after optimization in step t−1 is performed. ηₜ indicates an optimization rate of an architecture parameter during optimization in step t. δₜ indicates a learning rate of a model parameter during optimization in step t. Lₜᵣₐᵢₙ(wₜ₋₁,αₜ₋₁) indicates a loss function value of a loss function on a test set during optimization in step t. ∂_{α}Lₜᵣₐᵢₙ(wₜ₋₁,αₜ₋₁) indicates a gradient of the loss function on the test set relative to the architecture parameter α during optimization in step t. ∂_{w}Lₜᵣₐᵢₙ(wₜ₋₁,αₜ₋₁) indicates a gradient of the loss function on the test set relative to the model parameter w during optimization in step t.

In this embodiment, one-level optimization processing is performed on the architecture parameters and the model parameters in the second model, to implement optimization on the architecture parameters in the second model, so that the architecture parameters and the model parameters can be simultaneously optimized. Therefore, time consumed in an optimization process of the architecture parameters in the second model can be reduced, to further help improve efficiency of feature interaction item selection.

After step S330 is completed, in other words, feature interaction item selection is completed, the third model is a model obtained through feature interaction item selection.

In step S340, the third model is trained.

The third model may be trained, or the third model may be trained after a L1 regular term and/or a L2 regular term are/is added to the third model.

An objective of training the third model may be determined based on an application requirement.

For example, assuming that a CTR prediction model is to be obtained, the third model is trained by using the obtained CTR prediction model as the training objective, to obtain the CTR prediction model.

For another example, assuming that a CVR prediction model is to be obtained, the third model is trained by using the CVR prediction model as the training objective, to obtain the CVR prediction model.

Alternatively, the third model is a model obtained through feature interaction item deletion based on the first model. For details, refer to the foregoing description of step S330. Details are not described herein again.

Alternatively, the third model is a model obtained through feature interaction item deletion based on the second model. For details, refer to the foregoing description of step S330. Details are not described herein again.

It should be understood that through feature interaction item deletion (or selection), the architecture parameters are retained in the model to train the model, so that importance of the feature interaction item can be further learned.

It can be learned from the foregoing description that, in embodiments of this disclosure, the architecture parameters are introduced into the FM-based model, so that feature interaction item selection can be performed through optimization on the architecture parameters. In other words, in this disclosure, feature interaction item selection can be performed through optimization on the architecture parameters, and training for a plurality of candidate subsets in the conventional technology is not required. Therefore, this can effectively reduce a computing workload of FIS to save computing power, and improve efficiency of FIS.

In addition, in the solution provided in this embodiment of this disclosure, the feature interaction item in the FM-based model can be extended to a higher order.

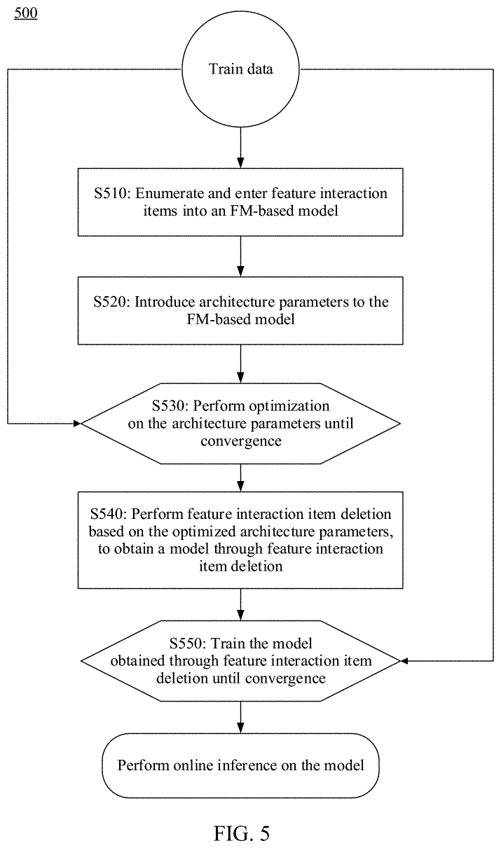

FIG. 5 is another schematic flowchart of an automatic FIS method 500 according to an embodiment of this disclosure.

First, training data is obtained.

For example, assuming that a quantity of features is m, the training data is obtained for features of m fields.

S510: Enumerate and enter feature interaction items into an FM-based model.

The FM-based model may be the FM model shown in the foregoing formula (1) or formula (2), or may be any one of the following FM-based models: a DeepFM model, an IPNN model, an AFM model, and an NFM model.

The enumerating and entering feature interaction items into an FM-based model means building, based on all interactions of m features, feature interaction items based on an FM model.

It should be understood that when the feature interaction items are being built, auxiliary vectors of m features are involved.

For example, the embedding layer shown in FIG. 1 or FIG. 3 may be used to obtain the auxiliary vectors of the m features. A technology of obtaining the auxiliary vectors of m features through the embedding layer belongs to a conventional technology. Details are not described in this specification.

S520: Introduce architecture parameters to the FM-based model. Further, one coefficient parameter is added to each feature interaction item in the FM-based model, and the coefficient parameter is referred to as an architecture parameter.

Step S520 is corresponding to step S310 in the foregoing embodiment. For specific descriptions, refer to the foregoing description.

The FM-based model in the embodiment shown in FIG. 5 is corresponding to the first model in the embodiment shown in FIG. 3, and a model obtained by adding an architecture parameter to the FM-based model in the embodiment shown in FIG. 5 is corresponding to the second model in the embodiment shown in FIG. 3.

S530: Perform optimization on the architecture parameters until convergence, to obtain the optimized architecture parameters.

Step S530 is corresponding to step S320 in the foregoing embodiment. For specific descriptions, refer to the foregoing description.

S540: Perform feature interaction item deletion based on the optimized architecture parameters, to obtain a model through feature interaction item deletion.

Step S540 is corresponding to step S330 in the foregoing embodiment. For specific descriptions, refer to the foregoing description.

The model obtained through feature interaction item deletion in the embodiment shown in FIG. 5 is corresponding to the third model in the embodiment shown in FIG. 3.

S550: Train the model obtained through feature interaction item deletion until convergence, to obtain a CTR prediction model.

Step S550 is corresponding to step S340 in the foregoing embodiment. For specific descriptions, refer to the foregoing description.

After the CTR prediction model is obtained through training, online inference may be performed on the CTR prediction model.

For example, data of a target object is input into the CTR prediction model, and the CTR prediction model outputs a CTR of the target object. Whether to recommend the target object may be determined based on the CTR.

An automatic FIS solution provided in this embodiment of this disclosure may be applied to any FM-based model, for example, an FM model, a DeepFM model, an IPNN model, an AFM model, and an NFM model.

In an example, the automatic FIS solution provided in this embodiment of this disclosure may be applied to an existing FM model.

For example, the architecture parameters are introduced into the existing FM model, so that importance of each feature interaction item is obtained through optimization on the architecture parameter. Then FIS is performed based on the importance of each feature interaction item, to finally obtain an FM model through FIS.

It should be understood that, the solution in this disclosure is applied to the FM model, so that feature interaction item selection of the FM model can be efficiently performed, to support extending the feature interaction item of the FM model to a higher order.

In another example, the automatic FIS solution provided in this embodiment of this disclosure may be applied to an existing DeepFM model.

For example, the architecture parameters are introduced into the existing DeepFM model, so that importance of each feature interaction item is obtained through optimization on the architecture parameter. Then FIS is performed based on the importance of each feature interaction item, to finally obtain a DeepFM through FIS.

It should be understood that, the solution in this disclosure is applied to the DeepFM model, so that feature interaction item selection of the DeepFM model can be efficiently performed.

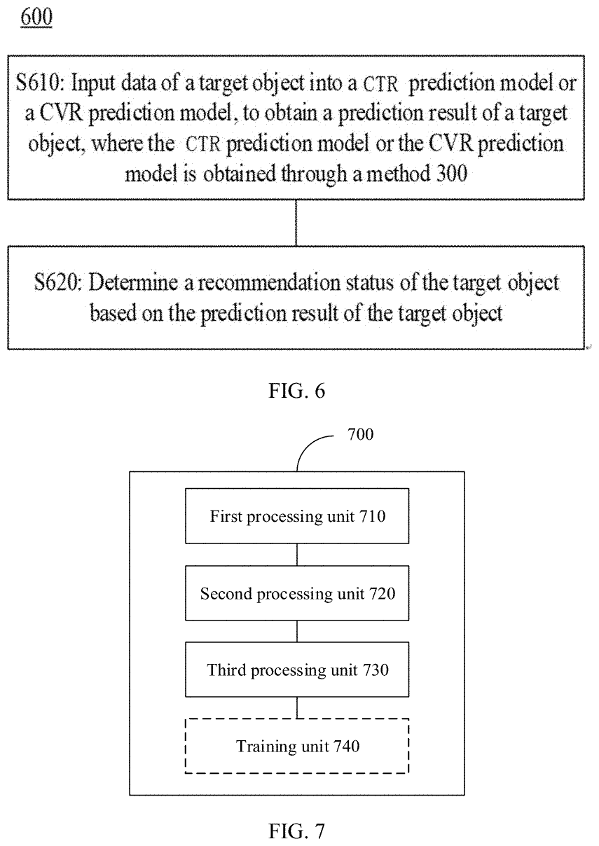

As shown in FIG. 6, this embodiment of this disclosure further provides a data processing method 600. The method 600 includes the following steps: S610 and S620.

S610: Input data of a target object into a CTR prediction model or a CVR prediction model, to obtain a prediction result of a target object.

For example, the target object is a commodity.

S620: Determine a recommendation status of the target object based on the prediction result of the target object.

The CTR prediction model or the CVR prediction model is obtained through the method 300 provided in the foregoing embodiment, that is, the CTR prediction model or the CVR prediction model is obtained through step S310 to step S340 in the foregoing embodiment. Refer to the foregoing description. Details are not described herein again.

In step S340, a third model is trained by using a training sample of the target object, to obtain the CTR prediction model or the CVR prediction model.

Optionally, in step S320, simultaneous optimization is performed on both architecture parameters and model parameters in a second model by using the same training data as that in the training sample of the target object, to obtain the optimized architecture parameters.

Alternatively, the architecture parameters and the model parameters in the second model are considered as decision variables at a same level, and simultaneous optimization is performed on both the architecture parameters and the model parameters in the second model by using the training sample of the target object, to obtain the optimized architecture parameters.

Simulation testing: CTR prediction accuracy of online A/B testing is significantly improved, and inference energy consumption is greatly reduced.

As an example, simulation testing shows that when the FIS solution provided in this disclosure is applied to the DeepFM model of a recommender system and online A/B testing is performed, a game download rate can be increased by 20%, a CTR prediction accuracy rate can be relatively improved by 20.3%, and a CVR can be relatively improved by 20.1%. Therefore, a model inference speed can be effectively improved.

In an example, an FM model and a DeepFM model are obtained on a public dataset Avazu by using the solution provided in this disclosure. Results of comparing performance of the FM model and the DeepFM model obtained by using the solution in this disclosure with performance of another model in the industry are shown in Table 1 and Table 2. Table 1 indicates comparison of second-order models, and Table 2 indicates comparison of third-order models. In the second-order mode, the highest order of a feature interaction item in a model is second order. In the third-order mode, the highest order of a feature interaction item in a model is third order.

TABLE 1

| | Public dataset Avazu | | | | | |
|---|---|---|---|---|---|---|
| | | | | Time in | Search + re-train | |
| | | | | seconds | cost in minutes | |
| Model | AUC | Log loss | Top | (s) | (min) | Rel. Impr |
| FM | 0.7793 | 0.3805 | 100% | 0.51 | 0 + 3 | 0 |
| FwFM | 0.7822 | 0.3784 | 100% | 0.52 | 0 + 4 | 0.37% |
| AFM | 0.7806 | 0.3794 | 100% | 1.92 | 0 + 14 | 0.17% |
| Field-Aware | 0.7831 | 0.3781 | 100% | 0.24 | 0 + 6 | 0.49% |
| FM (FFM) | | | | | | |
| DeepFM | 0.7836 | 0.3776 | 100% | 0.76 | 0 + 6 | 0.55% |
| GBDT + LR | 0.7721 | 0.3841 | 100% | 0.45 | 8 + 3 | −0.92% |
| GBDT + FFM | 0.7835 | 0.3777 | 100% | 2.66 | 6 + 21 | 0.54% |
| AutoFM (2nd) | 0.7831 | 0.3778 | 29% | 0.23 | 4 + 2 | 0.49% |
| AutoDeepFM | 0.7852 | 0.3765 | 24% | 0.48 | 7 + 4 | 0.76% |
| (2nd) | | | | | | |

TABLE 2

| | Public dataset Avazu | | | | | |
|---|---|---|---|---|---|---|
| | | | | | Search + re-train | |
| Model | AUC | Log loss | Top | Time (s) | cost (min) | Rel. Impr |
| FM (3rd) | 0.7843 | 0.3772 | 100% | 5.70 | 0 + 21 | 0.64% |
| DeepFM | 0.7854 | 0.3765 | 100% | 5.97 | 0 + 23 | 0.78% |
| (3rd) | | | | | | |
| AutoFM | 0.7860 | 0.3762 | 25%/2% | 0.33 | 22 + 5 | 0.86% |
| (3rd) | | | | | | |
| AutoDeepFM | 0.7870 | 0.3756 | 21%/10% | 0.94 | 24 + 10 | 0.99% |
| (3rd) | | | | | | |

In Table 1 and Table 2, meanings of horizontal table headers are as follows.

AUC represent area under curve which indicates an area under a curve. Log loss indicates log of a loss value. Top indicates a proportion of feature interaction items retained through feature interaction item selection. Time indicates a time period for a model to infer two million samples. Search+re-train cost indicates a time period consumed for search and retraining, where a time period consumed for search indicates a time period consumed for step S320 and step S330 in the foregoing embodiment, and a time period consumed for retraining indicates a time period consumed for step S340 in the foregoing embodiment. Rel.Impr indicates a relative increase value.

In Table 1, meanings of vertical table headers are as follows.

FM, Field-weighted FM (FwFM), AFM, FFM, and DeepFM represent FM-based models in the conventional technology. gradient boosting decision tree (GBDT)+ logistical regression (LR) and GBDT+FFM indicate models that use manual FIS in the conventional technology.

AutoFM (2nd) represents a second-order FM model obtained by using the solution provided in this embodiment of this disclosure. AutoDeepFM (2nd) represents a third-order DeepFM model obtained by using the solution provided in this embodiment of this disclosure.

In Table 2, meanings of vertical table headers are as follows.

FM (3rd) represents a third-order FM model in the conventional technology. DeepFM (3rd) represents a third-order DeepFM model in the conventional technology.

AutoFM (3rd) represents a third-order FM model obtained by using the solution provided in this embodiment of this disclosure. AutoDeepFM (3rd) represents a third-order DeepFM model obtained by using the solution provided in this embodiment of this disclosure.

It can be learned from Table 1 and Table 2 that, compared with the conventional technology, CTR prediction performed by using the FM model or the DeepFM model obtained in the solution provided in this embodiment of this disclosure can significantly improve CTR prediction accuracy, and can effectively reduce an inference time period and energy consumption.

It can be learned from the foregoing description that, in embodiments of this disclosure, the architecture parameters are introduced into the FM-based model, so that feature interaction item selection can be performed through optimization on the architecture parameters. In other words, in this disclosure, provided that optimization on the architecture parameters is performed once, feature interaction item selection can be performed, and training for a plurality of candidate subsets in the conventional technology is not required. Therefore, this can effectively reduce a computing workload of FIS to save computing power, and improve efficiency of FIS.

In addition, in the solution provided in this embodiment of this disclosure, the feature interaction item in the FM-based model can be extended to a higher order.

Embodiments described in this specification may be independent solutions, or may be combined based on internal logic. All these solutions fall within the protection scope of this disclosure.

The foregoing describes the method embodiments provided in this disclosure, and the following describes apparatus embodiments provided in this disclosure. It should be understood that descriptions of apparatus embodiments correspond to the descriptions of the method embodiments. Therefore, for content that is not described in detail, refer to the foregoing method embodiments. For brevity, details are not described herein again.

As shown in FIG. 7, this embodiment of this disclosure further provides a data processing apparatus 700. The apparatus 700 includes the following units.

A first processing unit 710 is configured to add an architecture parameter to each feature interaction item in a first model, to obtain a second model, where the first model is an FM-based model, and the architecture parameter represents importance of a corresponding feature interaction item.

A second processing unit 720 is configured to perform optimization on architecture parameters in the second model, to obtain the optimized architecture parameters.

A third processing unit 730 is configured to obtain, based on the optimized architecture parameters and the first model or the second model, a third model through feature interaction item deletion.

Optionally, the second processing unit 720 performs optimization on the architecture parameters, to allow the optimized architecture parameters to be sparse.

In this embodiment, the third processing unit 730 is configured to obtain, based on the first model or the second model, the third model by deleting a feature interaction item corresponding to an architecture parameter in the optimized architecture parameters whose value is less than a threshold.

Optionally, the second processing unit 720 performs optimization on the architecture parameters, to allow a value of an architecture parameter of at least one feature interaction item to be equal to zero after optimization is completed.

For example, the third processing unit 730 is configured to optimize the architecture parameters in the second model using a gRDA optimizer, where the gRDA optimizer allows the value of the architecture parameter of the at least one feature interaction item to tend to zero during an optimization process.

Optionally, the second processing unit 720 is further configured to perform optimization on model parameters in the second model, where optimization includes scalarization processing on the model parameters in the second model.

For example, the second processing unit 720 is configured to perform BN processing on the model parameters in the second model.

Optionally, the second processing unit 720 is configured to perform simultaneous optimization on both the architecture parameters and model parameters in a second model by using same training data, to obtain the optimized architecture parameters.

Optionally, the apparatus 700 further includes a training unit 740 configured to train the third model.

Optionally, the training unit 740 is configured to train the third model, to obtain a CTR prediction model or a CVR prediction model.

The apparatus 700 may be integrated into a terminal device, a network device, or a chip.

The apparatus 700 may be deployed on a compute node of a related device.

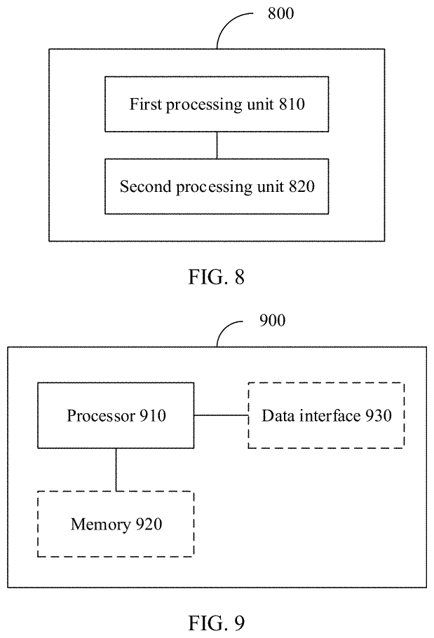

As shown in FIG. 8, this embodiment of this disclosure further provides an image processing apparatus 800. The apparatus 800 includes the following units.

A first processing unit 810 is configured to input data of a target object into a CTR prediction model or a CVR prediction model, to obtain a prediction result of the target object.

A second processing unit 820 is configured to determine a recommendation status of the target object based on the prediction result of the target object.

The CTR prediction model or the CVR prediction model is obtained through the method 300 or 500 in the foregoing embodiments.

Training of a third model includes the following step: train the third model by using a training sample of the target object, to obtain the CTR prediction model or the CVR prediction model.

Optionally, optimization on architecture parameters includes the following step: perform simultaneous optimization on both the architecture parameters and model parameters in a second model by using the same training data as that in the training sample of the target object, to obtain the optimized architecture parameters.

The apparatus 800 may be integrated into a terminal device, a network device, or a chip.

The apparatus 800 may be deployed on a compute node of a related device.

As shown in FIG. 9, this embodiment of this disclosure further provides an image processing apparatus 900. The apparatus 900 includes a processor 910, the processor 910 is coupled to a memory 920, the memory 920 is configured to store a computer program or instructions, and the processor 910 is configured to execute the computer program or the instructions stored in the memory 920, so that the method in the foregoing method embodiments is performed.

Optionally, as shown in FIG. 9, the apparatus 900 may further include a memory 920.

Optionally, as shown in FIG. 9, the apparatus 900 may further include a data interface 930, where the data interface 930 is configured to transmit data to the outside.

Optionally, in a solution, the apparatus 900 is configured to implement the method 300 in the foregoing embodiment.

Optionally, in another solution, the apparatus 900 is configured to implement the method 500 in the foregoing embodiment.

Optionally, in still another solution, the apparatus 900 is configured to implement the method 600 in the foregoing embodiment.

An embodiment of this disclosure further provides a computer-readable medium. The computer-readable medium stores program code to be executed by a device, and the program code is used to perform the method in the foregoing embodiments.

An embodiment of this disclosure further provides a computer program product including instructions. When the computer program product is run on a computer, the computer is enabled to perform the method in the foregoing embodiments.

An embodiment of this disclosure further provides a chip, and the chip includes a processor and a data interface. The processor reads, through the data interface, instructions stored in a memory to perform the method in the foregoing embodiments.

Optionally, in an implementation, the chip may further include a memory and the memory stores instructions, the processor is configured to execute the instructions stored in the memory, and when the instructions are executed, the processor is configured to perform the method in the foregoing embodiments.

An embodiment of this disclosure further provides an electronic device. The electronic device includes any one or more of the apparatus 700, the apparatus 800, or the apparatus 900 in the foregoing embodiments.

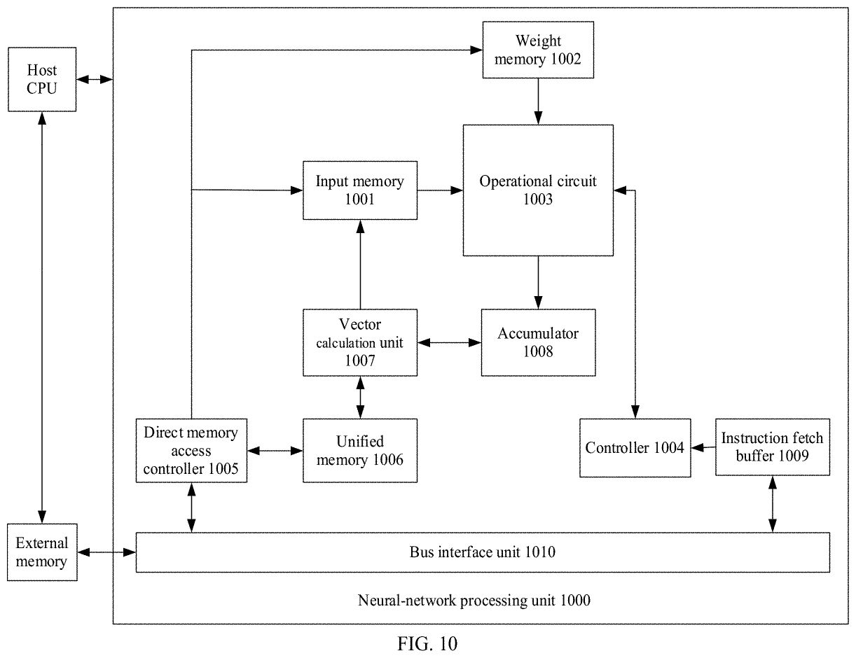

FIG. 10 is a schematic diagram of a hardware architecture of a chip according to an embodiment of this disclosure. The chip includes a neural-network processing unit 1000. The chip may be disposed in any one or more of the following apparatuses or systems: the apparatus 700 shown in FIG. 7, the apparatus 800 shown in FIG. 8, and the apparatus 900 shown in FIG. 9.

The method 300, 500, or 600 in the foregoing method embodiments may be implemented in the chip shown in FIG. 10.

The neural-network processing unit 1000 serves as a coprocessor, and is disposed on a host CPU. The host CPU assigns a task. A core part of the neural-network processing unit 1000 is an operational circuit 1003, and a controller 1004 controls the operational circuit 1003 to obtain data in a memory (a weight memory 1002 or an input memory 1001) and perform an operation.

In some implementations, the operational circuit 1003 includes a plurality of processing engines (PE). In some implementations, the operational circuit 1003 is a two-dimensional systolic array. Alternatively, the operational circuit 1003 may be a one-dimensional systolic array or another electronic circuit that can perform mathematical operations such as multiplication and addition. In some implementations, the operational circuit 1003 is a general-purpose matrix processor.

For example, it is assumed that there are an input matrix A, a weight matrix B, and an output matrix C. The operational circuit 1003 extracts corresponding data of the matrix B from a weight memory 1002, and buffers the corresponding data into each PE in the operational circuit 1003. The operational circuit 1003 fetches data of the matrix A from an input memory 1001, to perform a matrix operation on the matrix B, and stores an obtained partial result or an obtained final result of the matrix into an accumulator 1008.

A vector calculation unit 1007 may perform further processing such as vector multiplication, vector addition, an exponent operation, a logarithmic operation, or value comparison on output of the operational circuit 1003. For example, the vector calculation unit 1007 may be configured to perform network calculation, such as pooling, batch normalization, or local response normalization at a non-convolutional/non-fully connected (FC) layer in a neural network.

In some implementations, the vector calculation unit 1007 can store a processed output vector in a unified memory (or a unified buffer) 1006. For example, the vector calculation unit 1007 may apply a non-linear function to the output of the operational circuit 1003, for example, a vector of an accumulated value, to generate an activation value. In some implementations, the vector calculation unit 1007 generates a normalized value, a combined value, or both a normalized value and a combined value. In some implementations, the processed output vector can be used as an activation input for the operational circuit 1003, for example, used in a subsequent layer in the neural network.

The method 300, 500, or 600 in the foregoing method embodiments may be performed by 1003 or 1007.

The unified memory 1006 is configured to store input data and output data.

For weight data, a direct memory access controller (DMAC) 1005 directly transfers input data in an external memory to the input memory 1001 and/or the unified memory 1006, stores weight data in the external memory in the weight memory 1002, and stores data in the unified memory 1006 in the external memory.

A bus interface unit (BIU) 1010 is configured to implement interaction between the host CPU, the DMAC, and an instruction fetch buffer 1009 by using a bus.

The instruction fetch buffer 1009 connected to the controller 1004 is configured to store an instruction used by the controller 1004.

The controller 1004 is configured to invoke the instruction cached in the instruction fetch buffer 1009, to control a working process of an operation accelerator.

In this embodiment of this disclosure, the data herein may be to-be-processed image data.

Generally, the unified memory 1006, the input memory 1001, the weight memory 1002, and the instruction fetch buffer 1009 each are an on-chip memory. The external memory is a memory outside the NPU. The external memory may be a double data rate (DDR) synchronous dynamic random-access memory (SDRAM), a high bandwidth memory (HBM), or another readable and writable memory.

Unless otherwise defined, all technical and scientific terms used in this specification have same meanings as that usually understood by a person skilled in the art of this disclosure. The terms used in the specification of this disclosure are merely for the purpose of describing specific embodiments, and are not intended to limit this disclosure.

It should be noted that “first”, “second”, “third”, or “fourth”, and various numbers in this specification are merely used for differentiation for ease of description, and are not construed as a limitation to the scope of this disclosure.

A person skilled in the art may be aware that units and algorithm steps in the examples described with reference to the embodiments disclosed in this specification can be implemented by electronic hardware or an interaction of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments, and details are not described herein again.

In the several embodiments provided in this disclosure, it should be understood that the disclosed systems, apparatuses, and methods may be implemented in another manner. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communications connections may be implemented through some interfaces. The indirect couplings or communications connections between the apparatuses or units may be implemented in an electrical form, a mechanical form, or other forms.

The units described as separate parts may or may not be physically separate. Parts displayed as units may or may not be physical units, and may be located in one position or may be distributed on a plurality of network units. Some or all of the units may be selected based on actual requirements to achieve the objectives of the solutions in embodiments.

In addition, functional units in embodiments of this disclosure may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this disclosure essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some of the steps of the methods described in the embodiments of this disclosure. The foregoing storage medium includes any medium that can store program code, such as a Universal Serial Bus (USB) flash disk (UFD) (or a USB flash drive or a flash memory), a removable hard disk, a read-only memory (ROM), a random-access memory (RAM), a magnetic disk, or a compact disc. The UFD may also be briefly referred to as a USB flash drive or a USB flash drive.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

1. A method comprising:
adding first architecture parameters to first feature interaction items in a first model to obtain second model, wherein the first model is a factorization machine (FM)-based model, and wherein each of the first architecture parameters represents an importance of a corresponding feature interaction item;
performing a first optimization on second architecture parameters in the second model to obtain optimized architecture parameters; and
obtaining, based on the optimized architecture parameters and based on the first model or the second model, a third model through feature interaction item deletion.

2. The method of claim 1, wherein the first optimization allows the optimized architecture parameters to be sparse.

3. The method of claim 2, further comprising obtaining the third model by deleting a second feature interaction item corresponding to one of the second architecture parameters that is less than a threshold.

4. The method of claim 1, wherein a value of at least one of the first architecture parameters equal to zero after completing the first optimization.

5. The method of claim 4, further comprising performing the first optimization on the second architecture parameters using a generalized regularized dual averaging (gRDA) optimizer, wherein the gRDA optimizer allows values of the second architecture parameters to tend to zero during the first optimization.

6. The method of claim 1, further comprising performing a second optimization on model parameters in the second model, wherein the second optimization comprises scalarization processing on the model parameters.

7. The method of claim 6, wherein the second optimization further comprises batch normalization (BN) processing on the model parameters, wherein performing the first optimization and performing the second optimization comprises simultaneously performing the first optimization and the second optimization using the same training data, and wherein the method further comprises training the third model to obtain a click-through rate (CTR) prediction model or a conversion rate (CVR) prediction model.

8. A method comprising:
adding first architecture parameters to first feature interaction items in a first model to obtain to obtain a second model, wherein the first model is a factorization machine (FM)-based model, and wherein each of the first architecture parameters represents an importance of a corresponding feature interaction item;
performing a first optimization on second architecture parameters in the second model to obtain optimized architecture parameters;
obtaining, based on the optimized architecture parameters and based on the first model or the second model, a third model through feature interaction item deletion;
training the third model using a training sample of a target object to obtain a click-through rate (CTR) prediction model or a conversion rate (CVR) prediction model;
inputting data of the target object into the CTR prediction model or the CVR prediction model to obtain a prediction result of the target object; and
determining a recommendation result of the target object based on the prediction result.

9. The method of claim 8, wherein the first optimization allows the optimized architecture parameters to be sparse.

10. The method of claim 9, further comprising obtaining the third model by deleting a second feature interaction item corresponding to one of the second architecture parameters that is less than a threshold.

11. The method of claim 8, wherein a value of at least one of the first architecture parameters is equal to zero after completing the first optimization.

12. The method of claim 11, further comprising performing the first optimizations on the second architecture parameters using a generalized regularized dual averaging (gRDA) optimizer, wherein the gRDA optimizer allows values of the second architecture parameters to tend to zero during the first optimization.

13. The method of claim 8, further comprising performing a second optimization on model parameters in the second model, wherein the second optimization comprises scalarization processing on the model parameters.

14. The method of claim 13, wherein the second optimization comprises batch normalization (BN) processing on the model parameters, and wherein performing the first optimization and performing the second optimization comprises simultaneously performing the first optimization and the second optimization using the same training data.

15. An electronic device comprising:
a memory configured to store instructions; and
a processor coupled to the memory and configured to execute the instructions to cause the electronic device to:
add first architecture parameter to first feature interaction items in a first model to obtain a second model, wherein the first model is a factorization machine (FM)-based model, and wherein each of the first architecture parameters represents an importance of a corresponding feature interaction item;
perform a first optimization on second architecture parameters in the second model to obtain optimized architecture parameters; and
obtain, based on the optimized architecture parameters and based on the first model or the second model, a third model through feature interaction item deletion.

16. The electronic device of claim 15, wherein the processor is further configured to execute the instructions to cause the electronic device to obtain the third model by deleting a second feature interaction item corresponding one of the second architecture parameters that is less than a threshold.

17. The elecronic device of claim 15, wherein a value of at least one of the first architecture parameters is equal to zero after completing the first optimization.

18. The electronic device of claim 17, wherein the processor is further configured to execute the instructions to cause the electronic device to perform the first optimization on the second architecture parameters using a generalized regularized dual averaging (gRDA) optimizer, and wherein the gRDA optimizer allows values of the second architecture parameters to tend to zero during the first optimization.

19. The electronic device of claim 15, wherein the processor is further configured to execute the instructions to cause the electronic device to perform a second optimization on model parameters in the second model, and wherein the second optimization comprises scalarization processing on the model parameters.

20. The electronic device according to claim 19, wherein the first optimization allows the optimized architecture parameters to be sparse, wherein the second optimization comprises batch normalization (BN) processing on the model parameters, and wherein the processor is further configured to execute the instructions to cause the electronic device to:
simultaneously perform the first optimization and the second optimization using the same training data; and
train the third model to obtain a click-through rate (CTR) prediction model or a conversion rate (CVR) prediction model.
